(19) United States
(12) Patent Application Publication
(10) Pub. No.: US 2020/0410466 A1
(43) Pub. Date: Dec. 31, 2020

(54) ELECTRONIC INVOICE MANAGEMENT SYSTEM

(71) Applicant: H & S ENERGIE GMBH, Haar/Salmdorf (DE)

(72) Inventors: Reinhard HEYMANN, Haar/Salmdorf (DE); Johannes SCHLEMMER, Haar/Salmdorf (DE)

(21) Appl. No.: 16/957,042

(22) PCT Filed: Dec. 17, 2018
(86) PCT No.: PCT/EP2018/085135

§ 371 Date: Sep. 11, 2020

(30) Foreign Application Priority Data
Dec. 22, 2017 (DE) 10 2017 131 205.6

(51) Int. Cl. G06Q 20/10; G06Q 20/16; G06Q 20/32

(52) U.S. Cl. CPC G06Q 20/102; G06Q 40/025; G06Q 20/3278; G06Q 20/16

(57) ABSTRACT

A system for automatic invoice data management, wherein a buyer terminal, a seller payment receiving device, a seller processing and/or computing device and a server unit have a data connection via a communication network, wherein the seller payment receiving device has a capture module for capturing invoice document data and buyer and seller metadata linked thereto, which data can be transferred by the seller payment receiving device over the communication network to the server unit, and wherein the server unit has at least one invoice database unit in which the invoice document data can be stored and can be transferred automatically by the server unit over the communication network to the buyer terminal and the seller processing and/or computing device.

The present invention relates to a system for automatic invoice data management, comprising at least one buyer terminal, at least one buyer payment device, at least one seller payment receiving device, at least one seller processing and/or computing device, at least one central server unit and at least one communication network, wherein the buyer terminal, the seller payment receiving device, the seller processing and/or computing device and the server unit are in data connection by means of the communication network.

For simplifying electronic payment transactions between a buyer and a seller, a system for automatic invoice data management is proposed. This system is designed in particular to automatically send the specific invoice document data combined with the electronic payment transaction to the buyer and the seller as soon as the electronic payment transaction has been correctly performed. Systems for automatic invoice data management are already known from the state of the art.

DE 10 2010 038 729 A1 discloses a system for electronically capturing invoice data of a cost accounting, comprising means for creating a cost accounting, said cost accounting comprising invoice data; and means for electronically capturing and transmitting said invoice data to a data processing device.

From DE 20 2016 007 650 U1, an electronic transmission device including a near-field communication interface is further known, which is connected to existing cash systems for wireless transmission of electronic ESC/POS invoice data to mobile terminals and which receives said data from the same and sends them in a wireless manner to mobile terminals for reception by means of the near-field communication standard. In this process, the device is understood as a printing device which is external to the cash systems, so that these do not need to be fundamentally changed, but the proposed device only needs to be connected.

However, the systems for invoice data management already known from the state of the art are not equipped to be able to automatically transmit the corresponding invoice document data to buyers and sellers after a successful electronic payment transaction and to manage this data centrally.

It is the object of the present invention to further develop a system for automatic invoice data management of the type mentioned above in a beneficial manner, in particular to the effect that invoice document data of a buyer and seller can be managed and provided to them more easily and efficiently.

This object is achieved according to the invention by a system for automatic invoice data management comprising the features of claim 1. According to this, provision is made that a system for automatic invoice data management comprises at least one buyer terminal, at least one buyer payment device, at least one seller payment receiving device, at least one seller processing and/or computing device, at least one central server unit and at least one communication network, wherein the buyer terminal, the seller payment receiving device, the seller processing and/or computing device and the server unit are in data connection by means of the communication network, the seller payment receiving device comprising at least one capture module for capturing invoice document data and buyer and seller metadata combined with it, which can be transferred by the seller payment receiving device via the communication network to the server unit due to at least one electronic payment transaction having been correctly performed by means of the buyer payment device and the seller payment receiving device, wherein the server unit has at least one invoice database unit in which the invoice document data can be stored, which invoice document data can be automatically transferred by the server unit via the communication network to the buyer terminal and the seller processing and/or computing device.

The invention is based on the fundamental idea that the invoice document data and associated metadata generated as a result of an electronic payment transaction carried out between buyer and seller are transferable to a server unit, can be stored centrally in this server unit and automatically transferred by this server unit via the communication network to buyer and seller. This enables both buyers and sellers to check on the basis of the invoice document data immediately after the purchase or sale whether the payment transaction concerned has been carried out correctly. On the one hand, this makes electronic monetary transactions between buyer and seller significantly more secure, transparent and efficient, and thus simplifies them. On the other hand, the transfer of this electronic invoice document data means that a printout is not required, which further reduces the effort of invoice data management for both buyer and seller. In addition, by dispensing with these printouts, expensive and material-intensive resources such as printers and the corresponding printer paper can be saved. Basically, it is also possible to carry along relevant business documents such as invoices digitally at any time and anywhere, or basically to have access to these documents at any time and anywhere.

In addition, it is in particular conceivable that the buyer and seller can save the invoice document data sent to them on the buyer terminal and the seller processing and/or computing device. However, the buyer and the seller may also have access to the invoice document data stored in the server unit via the buyer terminal and the seller processing and/or computing device and download and manage it.

Furthermore, it is conceivable that the system for automatic invoice data management is also arranged and designed in such a way that invoice receipts or invoice document data may also be provided in the context with guarantees and/or warranty rights for the purchased product. In a warranty or guarantee case, the system can then be used to digitally carry along the corresponding receipts, so that they can also be accessed at any time and from anywhere. It is conceivable, for example, to simply transfer such data directly from the system to a corresponding module, e.g. in the seller processing and/or computing device. In particular, it is conceivable that this information can be called up via the buyer terminal and thus presented digitally. It is therefore no longer necessary to carry along paper receipts or the like.

It is also conceivable in this connection to be able to provide the corresponding tax documents directly.

Further, it is also conceivable that subsequent orders or returns can be processed via the system.

Furthermore, it may be provided that the server unit comprises at least one invoice data analysis module, which is in data connection with the invoice database unit and by means of which a determination of the creditworthiness and/or of a VAT rate and/or turnover tax rate can be performed on the basis of the stored invoice document data and/or a history of the invoice document data can be tracked. In particular, the invoice data analysis module is able to evaluate or analyze invoice document data of several invoices, whereby the buyer and the seller can be provided with detailed and accurate information on his electronic transactions (e.g. a certain period of time, items of expenditure, certain regions or countries or which trading partner). In addition, this evaluated invoice document data can be used in connection with the granting of credits or the conclusion of insurance contracts to the effect that the decision for a lender or an insurance company to grant credit or to conclude an insurance policy can be made more soundly. In addition, the invoice document data can be evaluated by means of the invoice data analysis module in such a way that a bonus or loyalty point system agreed between buyer and seller is taken into account and corresponding bonus and loyalty point data can be combined with the invoice document data.

Furthermore, it is conceivable that the server unit comprises at least one user profile database unit and at least one user profile data analysis module in mutual data connection, wherein unique buyer profile data and unique seller profile data are stored in the user profile database unit, wherein the buyer terminal and the seller payment receiving device are in data connection with the server unit provided that the buyer profile data are correctly matched with the seller profile data by the user profile data analysis module. Due to this comparison of the buyer profile data and the seller profile data by the user profile data analysis module, in particular the access security of the buyer terminal and the seller payment receiving device to the server unit can be significantly improved. Such an improvement in access is particularly important and advantageous for very sensitive data such as invoice document data. In particular, the access of the buyer terminal and the seller payment receiving device to the server unit via the communication network can be encrypted or coded, which further improves the access security. It is also conceivable in this context that the invoice document data is also encrypted or coded.

It is also conceivable that the system is set up and designed to process financial transactions between buyer and seller. It is conceivable, for example, that a so-called “digital payment” is made possible by means of the buyer terminal. It is also conceivable, however, that the payment flow can also function in the opposite direction, i.e. from the seller back to the buyer. This is particularly advantageous because in this case, for example, repayments or refunds can be made possible.

It is also conceivable that the buyer terminal is a personal computer, a tablet computer, a smartphone and/or a smartwatch, the seller payment receiving device being a card reader and the buyer payment device being a debit card. By designing the buyer terminal in this way, the buyer can constantly have access to the invoice document data which he can select, which results in particular in advantages for the buyer in terms of fast and efficient invoice data management and in terms of an overview of the invoice document data. In particular, it may be provided to advantage to design the buyer terminal as a mobile terminal. This makes it particularly easy for the buyer to access and manage the respective invoice document data from any location. Furthermore, debit cards and the correspondingly adapted card reader are standardized devices for the processing of electronic payment transactions between buyer and seller. This results in particular in advantages for the buyer and seller in terms of transaction security, transaction costs and transaction management.

Furthermore, it is possible that the user profile database unit stores buyer bank account data and seller bank account data which each can be combined with the buyer profile data and seller profile data by the user profile data analysis module. Thus, the effort for buyers and sellers regarding the management of the invoice document data can be further reduced, because several bank accounts can be combined with the buyer profile data and seller profile data by this combination.

The assignment to bank statements or other bank account data can also be automated. It is also conceivable, for example, to provide a corresponding display module on the buyer terminal, by means of which all bank data can be viewed directly online in order to be able to call up the corresponding financial data directly.

This display process can be done online in real time.

It is also conceivable that financial transactions are provided with corresponding warnings, which means, for example, that debits are shown or displayed as a message on the buyer terminal.

Furthermore, provision may be made that the invoice data analysis module and the user profile data analysis module are in data connection, so that the buyer profile data and the seller profile data can be also combined with the respective invoice document data to result in buyer link data and seller link data. In particular, due to this combination, even more detailed information regarding the invoice document data of buyers and sellers can be determined by the invoice data analysis module and the user profile data analysis module, whereby the management of the invoice document data can be further improved. It may also be envisaged that the invoice data analysis module and the user profile data analysis module are designed as a combined data analysis module. This allows sharing of many components, thus increasing the power density of such a data analysis module.

It is also conceivable that the invoice document data comprise a plurality of metadata containing payment information about payment amount, buyer, seller and the VAT and/or turnover tax number. Metadata are particularly advantageous for large quantities of invoice document data because they can be clearly summarized in this way so that they can be recorded, managed and processed quickly and efficiently by the invoice data analysis module.

Furthermore, it is conceivable that, as a result of the confirmation of a payment amount by the buyer and the seller and due to at least one electronic payment transaction having been correctly performed, the invoice document data and/or retailer receipt data of at least one card transaction can be automatically transferred by means of the seller payment receiving device via the communication network to the server unit and can be transferred back to the buyer terminal and the seller processing and/or computing device. Thus, a further security step can be provided which further reduces the error rate of electronic payment transactions and thus enables fast, transparent and in particular secure electronic financial transactions between buyer and seller.

Furthermore, it is possible that the invoice data analysis module allows to automatically calculate turnover and/or VAT data on the basis of the invoice document data and to combine it with the invoice document data. This way of tax calculation is particularly advantageous for commercial sellers, as the turnover and/or VAT amounts required for a VAT return, for instance, can be determined safely, easily and quickly using the system for automatic invoice data management. This circumstance can also be of interest to the buyer if, for example, he or she requires direct access to this data or document as a commercial buyer.

The system may also be set up and designed in such a way that online shops can also be integrated. Here, for example, invoices can be transferred directly online from the seller's system to the buyer's system and preferably also be stored and saved correctly in a direct manner.

A “direct pay” function may also be provided and available in this context.

In addition, provision may be made that the invoice data analysis module allows to automatically calculate the VAT and/or turnover tax rates and currencies of various countries on the basis of the invoice document data and to combine it with the invoice document data. Since the economic activities of commercial sellers are becoming increasingly globalized, a commercial seller in particular has a justified economic interest in ensuring that the turnover tax calculation can be further accelerated and simplified for foreign economic activities as well. These requirements can be implemented quickly and efficiently, especially with the system for automatic invoice data management, which is particularly advantageous for the user. This can also be of interest to the buyer, e.g. if relevant tax rates have to be calculated.

Furthermore, it is conceivable that the user profile data analysis module allows to combine the buyer profile data with at least one buyer email account and to combine the seller profile data with at least one seller email account, so that corresponding invoice document data can be automatically transferred to the buyer and seller via email by means of the server unit via the communication network to the buyer terminal and the seller processing and/or computing device. The provision of the respective invoice document data via email considerably facilitates the administration of the invoice document data for buyer and seller. Thus, a quick and easy forwarding of the invoice document data to the respective recipients can be carried out securely and in encrypted manner.

It is also conceivable that the user profile data analysis module allows to combine the buyer profile data and the seller profile data with further email accounts, so that invoice document data can be transferred via email to a tax consultant, auditor, a tax office or an airport department for turnover and VAT matters. This functionality of the system for automatic invoice data management is particularly advantageous in tax matters. This is because this system allows especially commercial buyers and sellers to forward the evaluated or analyzed invoice document data directly and thus particularly quickly and efficiently to tax consultants, auditors and tax offices, which also makes tax audits much more efficient, since they can be carried out electronically or digitally, and with higher transparency. A further functionality of this system is particularly important for those buyers and sellers who often transfer goods or services purchased in a first country to a second country with different VAT or turnover tax laws. In this case, the system can automatically analyze the corresponding invoice document data and use it to formulate corresponding VAT or turnover tax claims when crossing borders, e.g. at airports or customs stations. These can then be forwarded directly via email or similar transmission units, such as an online fax, SMS or any other messaging services, which also speeds up and simplifies this process.

It is also possible that invoice document data sent to the buyer and seller via email can be manually stored in the server unit by the buyer and seller by means of the buyer terminal and the seller processing and/or computing device. If the buyer or seller does not wish automatic storage of the invoice document data on the server, these can also be sent to him initially by email, so that he can decide manually whether the invoice document data should only be stored locally or additionally/alternatively on the server unit. This functionality increases the authority of buyers and sellers in the invoice document data management for rather small invoice document data volumes, as the freedom of decision to store the invoice document data can be made individually by buyers and sellers.

Furthermore, it may be provided that the invoice document data manually selected by the buyer and seller can be deleted by means of the buyer terminal and the seller processing and/or computing device. In this way, the buyer and seller can in particular remove invoice document data that is unimportant or barred and is no longer required for further business activities. The administrative effort for buyers and sellers or the processing speed and the storage space of the server unit, especially with large invoice document data volumes, can be further optimized.

It is also conceivable that the user profile data analysis module allows to combine the buyer profile data with at least one buyer user name and at least one buyer password and to combine the seller profile data with at least one seller user name and at least one seller password. This increases in particular the security of the invoice document data which is stored centrally on the server unit and is to be classified as very sensitive. In addition, there is the advantageous possibility that the invoice document data can be accessed by means of the respective user name and password by several persons authorized in this respect.

It is also conceivable that the invoice document data can be categorized in various storage folders in the invoice database unit by means of the invoice data analysis module. This allows a further optimization of the management of the invoice document data. Thus, different invoice document data can be stored and retrieved in different folders (e.g. food, clothing, entertainment, furniture, drugstore goods, health) in a particularly clear and simple way. This categorization is especially advantageous for external service providers such as tax consultants or auditors in tax computations, as the improved clarity also simplifies their work.

Furthermore, it is possible that the server unit comprises a search engine module, which is in data connection with the invoice data analysis module and the user profile data analysis module, and by means of which the invoice database unit and the user profile database unit is searchable according to specific search criteria which can be transferred to the search engine module by means of the buyer terminal and/or the seller processing and/or computing device via the communication network. The search engine module further simplifies the administration of the invoice document data. Finally, the buyer and seller are able to very easily find invoice document data assigned to specific search criteria (such as name, address, country, VAT number or tax number, product, barcode, matrix code, date or amount) and use it for their own purposes. The same also applies to external service providers such as tax consultants, tax offices or auditors, as this also makes their work much easier.

It is also conceivable that the invoice data analysis module allows, on the basis of the invoice document data, to automatically consider a debit order with discount and/or abatement and to combine it with the invoice document data. Since discounts or abatements are common in particular in buyer-seller relationships with a sufficiently large order volume, this function further simplifies the payment processing between buyer and seller. This also increases transparency for both buyer and seller, since the buyer and seller can quickly check whether the negotiated discounts or abatements have actually been taken into account in payment processing.

Furthermore, it is conceivable that the buyer terminal and the seller payment receiving device each comprise an NFC interface. The buyer terminal is advantageously equipped with an NFC interface if the buyer terminal is a mobile buyer terminal. By using a respective NFC interface, the use of a payment device such as a debit card is no longer necessary, at least not for the buyer. This makes the payment process more intuitive and easier, especially for the buyer. Furthermore, NFC technology offers versatile application possibilities in many industrial and commercial areas. In addition, NFC technology offers particularly secure data transmission due to its limitation to the short range, since, unlike WLAN-based transmission technologies, for example, it does not transmit the transferred data to a wider radius, making misuse more difficult. In addition, encrypted data transmission can be easily implemented using NFC technology.

Furthermore, it may be envisaged that the system for automatic invoice data management comprises at least one seller cash payment receiving device. The seller cash payment receiving device also includes an invoice document data capture module for cash payments from buyers and an identity capture module. Thus, by means of the identity capture module, identity data of at least one cash-paying buyer can be captured and transferred to the invoice document data capture module. During the cash payment process, the latter combines the resulting invoice document data with the buyer's identity data to form cash payment invoice document data and associated metadata. The identity capture module can capture the buyer's identity data during the cash payment process using a code that can be captured by the buyer's terminal device, an identity card or ID card, or other proof of identity. The seller cash payment receiving device is also in data connection with the server unit via the communication network. In other words, the seller cash payment receiving device can associate each cash payment with at least one buyer identity. In addition, the resulting cash payment invoice document data can be transferred to the server unit via the communication network. The cash payment invoice document data thus transferred to the server unit can be managed in the same or similar way as the invoice document data described above as a result of at least one electronic payment transaction. In particular, the cash payment invoice document data can be stored in the invoice database unit and automatically transferred by the server unit via the communication network to the buyer terminal and to the seller processing and/or computing device. Furthermore, it is possible to scan invoices by means of a scanning module and thus make them available in the system accordingly.

Furthermore, it is conceivable that the system for automatic invoice data management has at least one encryption module. Accordingly, the seller payment receiving device and the server unit may each have one encryption module. The encryption modules may in particular be set up to encrypt all data managed by the system (such as invoice document data and associated metadata, buyer profile data, seller profile data, buyer bank account data, seller bank account data, invoice document data, retailer receipt data, turnover tax data and/or VAT data). The encrypted data can thus be transferred in encrypted form via the communication network. The encryption methods that can be used for encryption can be symmetrical, asymmetrical or hybrid encryption methods. Examples of symmetrical encryption procedures include DES, 3DES, IDEA, CAST, RC4, RC5, RC5a, RC6, A5, Blowfish, Twofish and/or AES methods. Examples of asymmetric encryption methods can be Diffie-Hellman, RSA and/or ElGamal methods. Examples of hybrid encryption methods can be PGP methods as well as a combination of the aforementioned symmetrical and asymmetrical encryption methods. Furthermore, the buyer terminal, the seller processing and computing device and the server unit are set up to decrypt the encrypted data. The data managed by the system may also be encrypted end-to-end. Examples of an end-to-end encryption can be OpenPGP, S/MIME, the signal protocol, OTR, OMEMO and/or ZRTP/SRTP. Encryption can in particular increase data security with regard to the data managed by the system and thus reliably prevent unauthorized access to the data by third parties.

Further details and advantages of the invention shall now be explained on the basis of an exemplary embodiment shown in the drawing in which:

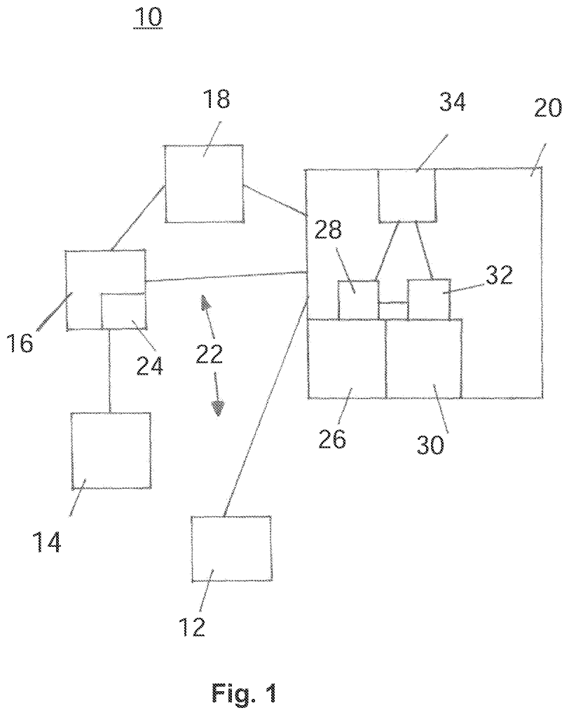

FIG. 1 shows a schematic representation of an exemplary embodiment of an automatic invoice data management system according to the invention.

FIG. 1 shows a schematic representation of an exemplary embodiment of a system 10, according to the invention, for automatic invoice data management.

The system 10 for automatic invoice data management comprises a buyer terminal 12, a buyer payment device 14, a seller payment receiving device 16, a seller processing and computing device 18, a central server unit 20 and a communication network 22.

It is also conceivable that the buyer terminal 12 can be or is connected to a printer, by means of which the receipts can also be printed. This can be used, for example, to make receipts available to the tax and/or revenue authorities.

The system can also be used to recognize cash withdrawals and correspondingly print out the incurring receipts.

According to a further exemplary embodiment, the system 10 for automatic invoice data management can additionally or alternatively have a seller cash payment receiving device (not shown in FIG. 1).

The seller cash payment receiving device may also have an invoice document data capture module for cash payments from buyers and an identity capture module (also not shown in FIG. 1). The buyer terminal 12, the seller payment receiving device 16, the seller processing and computing device 18 and the server unit 20 are in data connection via the communication network 22.

The buyer terminal 12 is either a personal computer, a tablet computer, a smartphone or a smartwatch.

The seller payment receiving device 16 is a card reader or an automatic teller machine.

Further, the buyer payment device 14 is a debit card.

According to another exemplary embodiment (not shown in FIG. 1), the buyer terminal 12 and the seller payment receiving device 18 may each have an NFC interface as well.

If the seller payment receiving device 16 is realized as a card reader, the NFC interface can be integrated into the card reader.

If the buyer terminal 12 has an NFC interface, the buyer terminal 12 is designed in particular as a mobile buyer terminal 12.

The seller payment receiving device 16 also has a capture module 24 for capturing invoice document data and associated buyer and seller metadata.

The server unit 20 also has an invoice database unit 26 and an invoice data analysis module 28.

The invoice data analysis module 28 is in data connection with the invoice database unit 26.

The server unit 20 further comprises a user profile database unit 30 and a user profile data analysis module 32 in mutual data connection.

The invoice data analysis module 28 and the user profile data analysis module 32 are also in data connection.

It is also conceivable that the invoice data analysis module 28 and the user profile data analysis module 32 are designed as a combined data analysis module.

The server unit 20 also has a search engine module 34, which is in data connection with the invoice data analysis module 28 and the user profile data analysis module 32.

The system 10 for automatic invoice data management can also have two encryption modules (not shown in FIG. 1).

According to this, the seller payment receiving device 16 and the server unit 20 may each have one encryption module. The function of the system 10 for automatic invoice data management can be described as follows:

As a result of a correctly performed electronic payment transaction (by means of the buyer payment device 14 and the seller payment receiving device 16), invoice document data and associated metadata can be transferred by the seller payment receiving device 16 via the communication network 22 to the server unit 20.

In this context, it is also conceivable that the invoice document data and the associated metadata are first transferable from the seller payment receiving device 16 to the seller processing and computing device 18 and from there are further transferred to the server unit 20.

Consequently, the seller payment receiving device 16 and the seller processing and computing device 18 are also in data connection via the communication network 22.

The communication network 22 can also be designed to be at least partially wireless, e.g. by means of WLAN.

It is also conceivable that the communication network 22 is designed to be at least partially wired.

To increase the security of the transferred invoice document data and of the associated metadata, the communication network 22 is encrypted.

As already explained above, the server unit 20 has an invoice database unit 26.

The invoice document data can be stored in said invoice database unit and automatically transferred by the server unit 20 via the communication network 22 to the buyer terminal 12 and to the seller processing and computing device 18.

The invoice document data can also be categorized in various storage folders in the invoice database unit 26 by means of the invoice data analysis module 28.

With the aid of the invoice data analysis module 28, a determination of the creditworthiness or of a VAT or turnover tax rate can be carried out on the basis of the stored invoice document data.

Furthermore, a history of the invoice document data can be tracked by means of the invoice data analysis module 28.

In this way, both buyers and sellers can quickly and easily figure out when, i.e. at what time and on what date, which payment transactions were processed with whom and where.

In addition, the user profile database unit 30 stores unique buyer profile data and unique seller profile data.

Furthermore, the user profile database unit 30 stores buyer bank account data and seller bank account data.

The buyer bank account data and seller bank account data can be respectively combined with the buyer profile data and the seller profile data by the user profile data analysis module 32.

Consequently, the buyer terminal 12 and the seller payment receiving device 16 are in data connection with the server unit 20, but only if the buyer profile data are correctly matched with the seller profile data by the user profile data analysis module 32.

If the buyer terminal 12 is used by one or more private persons, it can be a personal computer either used for business or private purposes.

In addition, the user profile data analysis module 32 allows to combine the buyer profile data with a buyer user name and a buyer password and to combine the seller profile data with a seller user name and at least one seller password.

As already explained above, the invoice data analysis module 28 and the user profile data analysis module 32 are in data connection.

Thus, the buyer profile data and the seller profile data can be also combined with the respective invoice document data to result in buyer link data and seller link data.

The invoice document data, in turn, comprises a plurality of metadata, which contain, for example, payment information about payment amount, buyer, seller and the VAT or turnover tax number.

Furthermore, as a result of a confirmation of a payment amount by the buyer and seller and as a result of a correctly performed electronic payment transaction, the invoice document data and, if applicable, the retailer receipt data of at least one card transaction can be automatically transferred by the system 10 to the server unit 20 via the communication network 22 by means of the seller payment receiving device 16.

From there, the invoice document data and, if applicable, the retailer receipt data can again be transferred back to the buyer terminal 12 and the seller processing and computing device 18.

Furthermore, the invoice data analysis module 28 allows to automatically calculate turnover and/or VAT data on the basis of the invoice document data and also to combine it with the invoice document data.

Furthermore, the invoice data analysis module 28 allows to automatically calculate the VAT and/or turnover tax rates and currencies of various countries on the basis of the invoice document data and then to combine it with the invoice document data.

In addition, it is possible that, by means of the invoice data analysis module 32 on the basis of the invoice document data, a debit order with discount or abatement can be automatically considered and combined with the invoice document data.

A further functionality of the system 10 is that the user profile data analysis module 32 allows to combine the buyer profile data with a buyer email account and to combine the seller profile data with at least one seller email account.

By means of this combination, corresponding invoice document data can be automatically transferred to the buyer and seller via email by means of the server unit 20 via the communication network 22 to the buyer terminal 12 and the seller processing and/or computing device 18.

In addition, the invoice document data EBD sent to the buyer and seller by e-mail can be stored manually by the buyer and seller in the server unit 20 by means of the buyer terminal 12 and the seller processing and computing device 18.

However, it is also conceivable in this context that the invoice document data manually selected by the buyer and seller can be deleted by means of the buyer terminal 12 and the seller processing and computing device 18.

By means of the user profile data analysis module 32, the buyer profile data and the seller profile data can be combined with further email accounts.

In this way, the respective invoice document data can be transferred via email to a tax consultant, an auditor, a tax office or airport department for turnover and VAT matters, for example.

In addition, invoice document data relating to a revoked electronic payment transaction can be transferred via email to buyers and sellers or printed out for paper-based documentation.

Invoice document data, which also relate to warranty claims or a replacement or reimbursement of products, can also be printed out as evidence.

The same applies to invoice document data that is used in connection with a tax advisor, auditor, tax office or airport department for turnover and VAT matters.

As explained above, the server unit 20 has a search engine module 34 which is in data connection with the invoice data analysis module 28 and the user profile data analysis module 32.

By means of the search engine module 34, the invoice database unit 26 and the user profile database unit 32 are searchable according to specific search criteria.

The corresponding search criteria can thus be transferred to the search engine module 32 via the communication network 22 by means of the buyer terminal 12 and the seller processing and computing device 18.

In addition, in the event of cash payment, identity data of at least one cash-paying buyer can be captured by means of the identity capture module and transferred to the invoice document data capture module.

During cash payment, the latter combines the resulting invoice document data with the identity data of the buyer to form cash payment invoice document data and associated metadata.

The identity capture module can capture the buyer identity data during the cash payment process using a code that can be captured by the buyer terminal, an identity card or passport, or other proof of identity.

The seller cash payment receiving device, in turn, is also in data connection with the server unit 20 via the communication network.

In other words, the seller cash payment receiving device can assign each cash payment to at least one buyer identity.

In addition, the resulting cash payment invoice document data can be transferred to the server unit 18 via the communication network 22.

The cash payment invoice document data thus transferred to the server unit 18 can be managed in the same or similar way as the invoice document data described above as a result of at least one electronic payment transaction.

In particular, the cash payment invoice document data can be stored in the invoice database unit 26 and automatically transferred by the server unit 18 via the communication network 22 to the buyer terminal 12 and to the seller processing or computing device 18.

Furthermore, all data managed by the system 10 can be encrypted by the encryption modules described above.

The encryption module of the seller payment receiving device 16 can therefore encrypt invoice document data and associated metadata as well as retailer receipt data.

Accordingly, the encryption module of the server unit 20 is able to encrypt buyer profile data, seller profile data, buyer bank account data, seller bank account data, turnover tax data and/or VAT data.

The encrypted invoice document data and associated metadata and retailer receipt data received by the server unit 20 can first be decrypted by means of a decryption module of the server unit 20 before they are further processed and re-encrypted by the server unit 20.

The data encrypted in this way can therefore always be transferred in encrypted form via the communication network 22.

The encryption methods that can be used by the encryption modules can be symmetric, asymmetric or hybrid encryption methods.

Examples of symmetric encryption procedures include DES, 3DES, IDEA, CAST, RC4, RC5, RC5a, RC6, A5, Blowfish, Twofish or AES methods.

Examples of asymmetric encryption methods include Diffie-Hellman, RSA or ElGamal methods.

Examples of hybrid encryption methods include PGP methods as well as a combination of the symmetrical and asymmetrical encryption methods mentioned above.

Furthermore, the buyer terminal 12 and the seller processing and computing device 18 are adapted to decrypt the encrypted data.

The data managed by the system 10 can also be encrypted in end-to-end fashion.

Examples of end-to-end encryption include OpenPGP, S/MIME, the signal protocol, OTR, OMEMO and/or ZRTP/SRTP.

### LIST OF REFERENCE NUMERALS

10 System for automatic invoice data management
12 Buyer terminal
14 Buyer payment device
16 Seller payment receiving device
18 Seller processing and computing device
20 Server unit
22 Communication network
24 Capture module for capturing invoice document data
26 Invoice database unit
28 Invoice data analysis module
30 User profile database unit
32 User profile data analysis module
34 Search engine module

1. A system for automatic invoice data management, comprising at least one buyer terminal, a least one buyer payment device, at least one seller payment receiving device, at least one seller processing and/or computing device, at least one central server unit and at least one communication network, wherein the buyer terminal, the seller payment receiving device, the seller processing and/or computing device and the server unit are in data connection by means of the communication network, the seller payment receiving device comprising at least one capture module for capturing invoice document data and buyer and seller metadata combined with it, which can be transferred by the seller payment receiving device via the communication network to the server unit due to at least one electronic payment transaction having been correctly performed by means of the buyer payment device and the seller payment receiving device, wherein the server unit has at least one invoice database unit in which the invoice document data can be stored, which invoice document data can be automatically transferred by the server unit via the communication network to the buyer terminal and the seller processing and/or computing device.

2. The system for automatic invoice data management according to claim 1, wherein the server unit comprises at least one invoice data analysis module, which is in data connection with the invoice database unit and by means of which a determination of creditworthiness and/or of a VAT rate and/or turnover tax rate can be performed on a basis of a stored invoice document data and/or a history of the invoice document data can be tracked.

3. The system for automatic invoice data management according to claim 2, wherein the server unit comprises a user profile database unit and a user profile data analysis module in mutual data connection, wherein unique buyer profile data and unique seller profile data are stored in the user profile database unit, wherein the buyer terminal and the seller payment receiving device are in data connection with the server unit provided that the buyer profile data are correctly matched with the seller profile data by the user profile data analysis module.

4. The system for automatic invoice data management according to claim 1, wherein the buyer terminal is a personal computer, a tablet computer, a smartphone and/or a smartwatch, the seller payment receiving device being a card reader and the buyer payment device being a debit card.

5. The system for automatic invoice data management according to claim 3, wherein the user profile database unit stores buyer bank account data and seller bank account data which each can be combined with buyer profile data and seller profile data by the user profile data analysis module.

6. The system for automatic invoice data management according to claim 5, wherein the invoice data analysis module and the user profile data analysis module are in data connection, so that the buyer profile data and the seller profile data can be also combined with respective invoice document data to result in buyer link data and seller link data.

7. The system for automatic invoice data management according to claim 2, wherein the invoice document data comprise a plurality of metadata containing payment information about payment amount, buyer, seller and the VAT and/or turnover tax number.

8. The system for automatic invoice data management according to claim 1, wherein as a result of confirmation of a payment amount by the buyer and the seller and due to at least one electronic payment transaction having been correctly performed, the invoice document data and/or retailer receipt data of at least one card transaction can be automatically transferred by means of the seller payment receiving device via the communication network to the server unit and can be transferred back to the buyer terminal and the seller processing and/or computing device.

9. The system for automatic invoice data management according to claim 2, wherein the invoice data analysis module allows to automatically calculate turnover and/or VAT data on the basis of the invoice document data and to combine it with the invoice document data.

10. The system for automatic invoice data management according to claim 2, wherein the invoice data analysis module (28) allows to automatically calculate the VAT and/or turnover tax rates and currencies of various countries on the basis of the invoice document data and to combine it with the invoice document data.

11. The system for automatic invoice data management according to claim 3, wherein the user profile data analysis module allows to combine the buyer profile data with at least one buyer email account and to combine the seller profile data with at least one seller email account, so that corresponding invoice document data can be automatically transferred to the buyer and seller via email by means of the server unit via the communication network to the buyer terminal and the seller processing and/or computing device.

12. The system for automatic invoice data management according to claim 11, wherein the user profile data analysis module allows to combine the buyer profile data and the seller profile data with further email accounts, so that invoice document data can be transferred via email to a tax consultant, auditor, a tax office or an airport department for turnover and VAT matters.

13. The system for automatic invoice data management according to claim 11, wherein invoice document data (EBD) sent to the buyer and seller via email can be manually stored in the server unit by the buyer and seller by means of the buyer terminal and the seller processing and/or computing device.

14. The system for automatic invoice data management according to claim 1, wherein the invoice document data manually selected by the buyer and seller can be deleted by means of the buyer terminal (12) and the seller processing and/or computing device (18).

15. The system for automatic invoice data management according to claim 3, wherein the user profile data analysis module allows to combine the buyer profile data with at least one buyer user name and at least one buyer password and to combine the seller profile data with at least one seller user name and at least one seller password.

16. The system for automatic invoice data management according to claim 2, wherein the invoice document data can be categorized in various storage folders in the invoice database unit by means of the invoice data analysis module.

17. The system for automatic invoice data management according to any of the preceding claim 3, wherein the server unit comprises a search engine module (34), which is in data connection with the invoice data analysis module (28) and the user profile data analysis module (32), and by means of which the invoice database unit (26) and the user profile database unit (32) is searchable according to specific search criteria which can be transferred to the search engine module by means of the buyer terminal (12) and/or the seller processing and/or computing device via the communication network.

18. The system for automatic invoice data management according to claim 2, wherein the invoice data analysis module allows, on the basis of the invoice document data, to automatically consider a debit order with discount and/or abatement and to combine it with the invoice document data.

19. The system for automatic invoice data management according to claim 1, wherein the buyer terminal and the seller payment receiving device each comprise an NFC interface.
